(19) United States
(12) Patent Application Publication
(10) Pub. No.: US 2024/0380434 A1
(43) Pub. Date: Nov. 14, 2024

(54) CHANNEL FEEDBACK METHOD, PRE-CODING MATRIX ADJUSTMENT METHOD, WIRELESS COMMUNICATION DEVICE AND BASE STATION

(71) Applicant: Sony Group Corporation, Tokyo (JP)

(72) Inventors: Ziyuan SHA, Beijing (CN); Zhaocheng WANG, Beijing (CN); Jianfei CAO, Beijing (CN)

(73) Assignee: Sony Group Corporation, Tokyo (JP)

(21) Appl. No.: 18/691,054

(22) PCT Filed: Sep. 23, 2022
(86) PCT No.: PCT/CN2022/120699

§ 371 Date: Mar. 12, 2024

(30) Foreign Application Priority Data
Sep. 30, 2021 (CN) 202111160959.8

(51) Int. Cl. H04B 7/024; H04B 7/06; H04L 5/00

(52) U.S. Cl. CPC H04B 7/024; H04B 7/0626; H04B 7/063; H04L 5/0051

(57) ABSTRACT

A method includes calculating, by a joint transmission user, a first and a second equivalent channel matrix from the first base station and the second base station to the user; feeding back a first matrix to the first base station based on the first equivalent channel matrix, and feeding back a second matrix to the second base station based on the second equivalent channel matrix; receiving the pre-coded first data demodulation reference signal from the first base station and the pre-coded second data demodulation reference signal from the second base station, and then calculating a decoding matrix, wherein the number of columns of the first feedback equivalent channel matrix and the number of columns of the second equivalent channel matrix are equal to or less than the sum of the number of data layers of the first base station and the second base station.

### CROSS-REFERENCE TO RELATED APPLICATION

This application claims the benefit of Chinese Patent Application No. 202111160959.8, filed on Sep. 30, 2021 to China National Intellectual Property Administration, which is incorporated herein by reference in its entirety.

### TECHNICAL FIELD

The present invention relates to the field of wireless communications. More particularly, the present invention relates to a channel feedback method, a pre-coding matrix adjustment method, and a wireless communication device and a base station in an application scenario where Multi-User Multiple-Input Multiple-Output (MU-MIMO) technology is combined with Non-coherent Joint Transmission (NCJT) technology.

### BACKGROUND ART

As a key technology of the fifth-generation mobile communication network (5G), the MU-MIMO technology has been widely used. In a MU-MIMO system, a base station uses the same time-frequency resource to simultaneously serve a plurality of mobile communication devices, i.e., a plurality of users (UEs), and each base station simultaneously communicates with the plurality of UEs by making full use of the space domain resource of an antenna, thereby achieving space division multiple access of the plurality of UEs. Therefore, compared to the single-user MIMO (SU-MIMO), the MU-MIMO system can significantly improve the system throughput without increasing the spectrum resources. In the MU-MIMO system, however, there is a problem of how to eliminate co-channel interference between multiple UEs within the same user group. At present, the more popular technique for canceling interference between UEs is implemented by a pre-coding technique at the base station side. This pre-coding operation at the base station side is performed based on the channel matrix fed back to the base station side through the type II codebook at the UE side. This MU-MIMO channel feedback is already supported in the current 5G NR standard. On the other hand, NCJT has been widely used in the SU-MIMO system as another technical solution supported by 5G NR standard. In the NCJT technique, two base stations can transmit independent data streams to the same UE, data transmission for one or more UEs is jointly processed among a plurality of cells, and a plurality of signals received in a predetermined UE are non-coherently combined with each other in order to enhance signal power and reduce inter-cell interference.

In MU-MIMO systems, MU-MIMO can be considered in combination with NCJT in order to enhance the coverage of UEs in cell-edge areas and reduce the interference between multiple users.

### SUMMARY OF THE INVENTION

### Technical Problem to be Solved

However, when combining MU-MIMO with NCJT, since the number of columns of the feedback channel matrix used in the prior art is the number of data layers of the base station, such a feedback method is insufficient for a joint transmission UE to simultaneously achieve both avoiding interference from other UEs served by two base stations and better separating and demodulating data from the two base stations. Therefore, there is a need to improve the current feedback approach. In addition, since the MU-MIMO pre-coding matrices of the same joint transmission UE at the two base station sides are set independently by the two base stations, the resulting equivalent channel matrix may be under-rank, resulting in degraded channel quality.

Accordingly, for the above problems in the prior art, the present invention provides a channel feedback method, a pre-coding matrix adjustment method, and a wireless communication device and a base station capable of satisfying a channel feedback requirement in a case where MU-MIMO and NCJT are combined.

### Technical Solution

The technical problem to be solved by the present invention is achieved by the following technical solution.

According to an embodiment of the present invention, a method for performing channel feedback at a user side under non-coherent joint transmission is provided. The method includes the following steps: a joint transmission user receives a first channel state information reference signal from a first base station, and receives a second channel state information reference signal from a second base station; the joint transmission user calculates a first equivalent channel matrix from the first base station to a first channel of the joint transmission user based on the first channel state information reference signal, and calculates a second equivalent channel matrix from the second base station to a second channel of the joint transmission user based on the second channel state information reference signal; the joint transmission user feeds back a first feedback equivalent channel matrix to the first base station based on the first equivalent channel matrix, and feeds back a second feedback equivalent channel matrix to the second base station based on the second equivalent channel matrix; the joint transmission user receives a first data demodulation reference signal pre-coded by a first pre-coding matrix from the first base station and a second data demodulation reference signal pre-coded by a second pre-coding matrix from the second base station, the joint transmission user then calculates a decoding matrix based on the first data demodulation reference signal and the second data demodulation reference signal, and the joint transmission user can decode data from the first base station and the second base station based on the decoding matrix, and the number of columns of the first feedback equivalent channel matrix and the number of columns of the second equivalent channel matrix are both equal to or less than the sum of the number of data layers of the first base station and the number of data layers of the second base station.

According to an embodiment of the present invention, a wireless communication device is provided. The wireless communication device can perform channel feedback with the base station using the channel feedback method described above under non-coherent joint transmission.

According to an embodiment of the present invention, a method for processing channel feedback at a base station side under non-coherent joint transmission is provided. The method includes the following steps: a first base station transmits a first channel state information reference signal to a joint transmission user, so that the joint transmission user calculates a first equivalent channel matrix of a first channel from the first base station to the joint transmission user based on the first channel state information reference signal; and the second base station transmits a second channel state information reference signal to the joint transmission user, so that the joint transmission user calculates a second equivalent channel matrix of a second channel from the second base station to the joint transmission user based on the second channel state information reference signal; the first base station receives a first feedback equivalent channel matrix based on the first equivalent channel matrix feedback from the joint transmission user, and the second base station receives a second feedback equivalent channel matrix based on the second equivalent channel matrix feedback from the joint transmission user; the first base station calculates a first pre-coding matrix based on the first feedback equivalent channel matrix, and transmits a first data demodulation reference signal pre-coded by the first pre-coding matrix to the joint transmission user; the second base station calculates a second pre-coding matrix based on the second feedback equivalent channel matrix, and transmits a second data demodulation reference signal pre-coded by the second pre-coding matrix to the joint transmission user, wherein the first pre-coding matrix and the second pre-coding matrix are used for avoiding the interference of other users served by the first base station and the second base station on the signals of the joint transmission user, and wherein The number of columns of the first feedback equivalent channel matrix and the number of columns of the second equivalent channel matrix are both equal to or less than the sum of the number of data layers of the first base station and the number of data layers of the second base station.

According to an embodiment of the present invention, a base station is provided. The base station can process channel feedback from the wireless communication device using the processing methods described above under non-coherent joint transmission.

According to an embodiment of the present invention, a method for adjusting a pre-coding matrix at a base station side under non-coherent joint transmission is provided. Under the non-coherent joint transmission, a first base station transmitting data pre-coded by a first pre-coding matrix to a joint transmission user via a first channel, a second base station transmitting data pre-coded by a second pre-coding matrix to the joint transmission user via a second channel, the first channel having a first equivalent channel matrix, and the second channel having a second equivalent channel matrix, The adjustment method includes the following steps: the first base station and/or the second base station receive indication information from the joint transmission user, and determine that the pre-coded first equivalent channel matrix and/or the second equivalent channel matrix are under-rank based on the indication information; the first base station and/or the second base station then adjust the target pre-coding vector and obtain a modified first pre-coding matrix and/or a modified second pre-coding matrix according to the target pre-coding vector needing to be adjusted of the first pre-coding matrix and/or the second pre-coding matrix indicated in the indication information, and transmit the first data demodulation reference signal and/or the second data demodulation reference signal pre-coded by the modified first pre-coding matrix and/or the modified second pre-coding matrix to the joint transmission user.

### Technical Effects

According to the present invention, when performing wireless communication between a base station and a joint transmission user in a NCJT scenario, since a channel state can be flexibly fed back according to an actual situation of a channel, interference from other UEs served by the base station can be avoided, while data from the base station can be well separated and demodulated. The present invention achieves a good compromise between communication performance and feedback overhead.

### BRIEF DESCRIPTION OF THE DRAWINGS

The accompanying drawings constituting a part of the present application are used to provide a further understanding of the present invention. The exemplary examples of the present invention and descriptions thereof are used to explain the present invention, and do not constitute an improper limitation of the present invention. In the drawings:

FIG. 1 is a schematic diagram illustrating an MU-MIMO system model in a NCJT scenario according to an embodiment of the present invention;

FIG. 2 is a schematic diagram illustrating a simplified model of an MU-MIMO system in a NCJT scenario according to an embodiment of the present invention;

FIG. 3 is a flowchart illustrating a channel feedback method according to an embodiment of the present invention;

FIG. 4 is a scenario diagram illustrating a simulation experiment of a channel feedback method according to an embodiment of the present invention;

FIG. 5 shows a result of a simulation experiment of a channel feedback method according to an embodiment of the present invention;

FIG. 6 is a diagram illustrating an example of low-rank data layer indication information of a pre-coding matrix adjustment method according to an embodiment of the present invention;

FIG. 7 shows simulation results of simulation experiments of a pre-coding matrix adjustment method according to an embodiment of the present invention;

FIG. 8 is a flowchart illustrating a channel feedback method of a variant according to an embodiment of the present invention.

### DETAILED DESCRIPTION OF THE INVENTION

The technical solutions of the embodiments of the present invention will be clearly and completely described below with reference to the accompanying drawings, and it is obvious that the embodiments described herein are only illustrative and not all embodiments of the present invention. It is to be understood that, based on the embodiments of the present invention, all other embodiments which can be obtained by a person skilled in the art without inventive effort fall within the scope of the present invention.

Detailed description of the present invention is described herein in the following order.
1. Overview of an MU-MIMO system model in a NCJT scenario
2. Problems of existing MU-MIMO channel feedback methods
3. A channel feedback method according to an embodiment of the present invention
3.1 Schematic illustration of a channel feedback method according to an embodiment of the present invention
3.2 Simulation results of a channel feedback method according to an embodiment of the present invention
4. A pre-coding matrix adjustment method according to an embodiment of the present invention
5. A variant of the channel feedback method according to an embodiment of the present invention

### 1. Overview of an MU-MIMO System Model in a NCJT Scenario

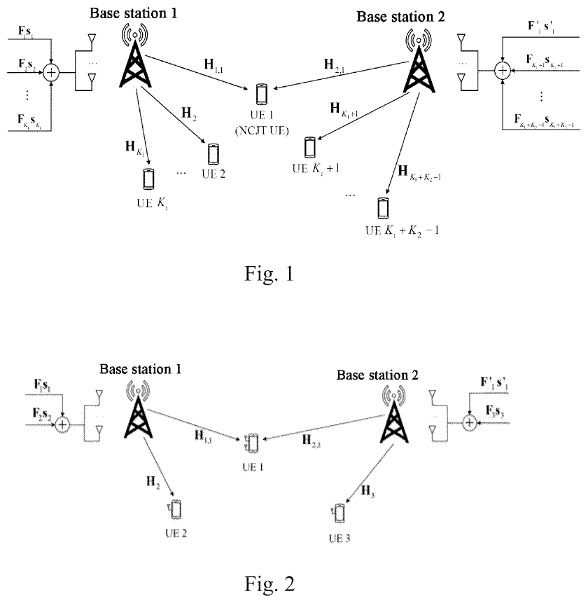

First, an overview of the MU-MIMO system model in the NCJT scenario will be described with reference to FIG. 1. For simplicity of explanation, the following description will take the MU-MIMO system of two base stations as an example, but the model is obviously equally applicable to the MU-MIMO system of more base stations.

In FIG. 1, a base station 1 and a base station 2 serve a plurality of UEs, respectively. For simplicity of illustration, the case where only one UE is at a margin of a cell and acts as a NCJT UE is presented herein. As shown, UE 1 is a NCJT UE.

In the NCJT scenario, base station 1 and base station 2 inform their respective physical downlink shared channel (PDSCH) to UE 1 through respective Downlink Control Information (DCI). The transmitted signal vectors from the base station 1 and the base station 2 to the UE 1 are denoted by s₁∈C^{v×1} and s′₁∈C^{v′×1} respectively, wherein v and v′ represent the number of data layers transmitted between the base station 1 and the base station 2 to the UE 1 respectively. In other words, UE 1 receives two layers of data s₁ and s′₁ from the base station 1 and the base station 2. The channel matrices from the base station 1 and the base station 2 to the UE 1 are denoted by

$${H}_{1 , 1} ∈ {C}^{{N}_{r} \times {N}_{{t}_{1}}} and {H}_{2 , 1} ∈ {C}^{{N}_{r} \times {N}_{{t}_{2}}}$$

respectively, where Nₜ_{₁} and Nₜ_{₂} represent the number of transmitting antenna ports of the base station 1 and the base station 2 respectively, and Nᵣ represents the number of receiving antennas of the UE 1. The pre-coding matrices from the base station 1 and the base station 2 to the UE 1 can be denoted by

$${F}_{1} ∈ {C}^{{N}_{{t}_{1}} \times v} and {{F}^{′}}_{1} ∈ {C}^{{N}_{{t}_{2}} \times v ′}$$

respectively.
In addition to the UE 1, the base station 1 serves the UE 2 to the UE K₁ by means of MU-MIMO, and the UE 2 to the UE K₁ respectively receive a layer of data from the base station 1. From the base station 1 to the UE K₁, the transmitted signal vector of the k₁=2, . . . , K₁ is denoted by Sky′ the channel matrix by Hₖ_{₁} and the pre-coding matrix by Fₖ_{₁}.

In addition to the UE 1, the base station 2 also serves the UE (K₁+1) to UE (K₁+K₂−1)) by means of MU-MIMO, and the UE (K₁+1) to UE (K₁+K₂−1)) respectively receive a layer of data from the base station 2. From the base station 2 to the UE k₂, the transmitted signal vector of the k₂=K₁+1, . . . , K₁+K₂−1 is denoted by sₖ_{₂}, the channel matrix by Hₖ_{₂} and the pre-coding matrix by Fₖ_{₂}.

The received signal y∈C^{N}^{ᵣ}^{×1} of the UE 1 can be represented by the following Formula (1):

$$y = {H}_{1 , 1} {F}_{1} {s}_{1} + {H}_{2 , 1} {F}_{1}^{′} {s}_{1}^{′} + {\sum }_{{k}_{1} = 2}^{{K}_{1}} {H}_{1 , 1} {F}_{{k}_{1}} {s}_{{k}_{1}} + {\sum }_{{k}_{2} = {K}_{1} + 1}^{{K}_{1} + {K}_{2} - 1} {H}_{2 , 1} {F}_{{k}_{2}} {s}_{{k}_{2}} + n \qquad ( 1 )$$

Where n∈C^{N}^{ᵣ}^{×1} is thermal noise.

In the above expressions, the first item and the second item are the received signals that we expect to be received by UE 1, while the third item Σ_{K}_{₁}₌₂^{K}^{₁}H_{1,1}Fₖ_{₁}sₖ_{₁} is the interference of the signals transmitted by base station 1 to the served other UEs to the received signals of UE 1, and the fourth item Σₖ_{₂}_{=K}_{₁}₊₁^{K}^{₁}^{+K}^{₂}⁻¹H_{2,1}Fₖ_{₂}sₖ_{₂} is the interference of the signals transmitted by base station 2 to the served other UEs to the received signals of UE 1.

For ease of understanding, we further illustrate the case where k₁=2 and k₂=3 and UE 1 has 2 Rx antennas and UE 2 and UE 3 both have 1 Rx antenna. In this case, as shown in FIG. 2, the channel matrices of the base station 1 to the UE 1 are denoted by h_{1,1}^{H} and h_{1,2}^{H}, respectively; the channel matrices of the base station 2 to the UE 1 are denoted by h_{2,1}^{H} and h_{2,2}^{H}, respectively, the channel matrices of the base station 1 to the UE 2 are denoted by h₂^{H}, and the channel matrices of the base station 2 to the UE 3 are denoted by h₃^{H}.

In this case, the received signal y of the UE 1 can be represented by the following Formula (2):

$$y = [ \begin{matrix}{h}_{1 , 1}^{H} {f}_{1} & {h}_{2 , 1}^{H} {{f}^{′}}_{1} \\ {h}_{1 , 2}^{H} {f}_{1} & {h}_{2 , 2}^{H} {{f}^{′}}_{1}\end{matrix} ] [ \begin{matrix}{s}_{1} \\ {{s}^{′}}_{1}\end{matrix} ] + [ \begin{matrix}{h}_{1 , 1}^{H} {f}_{2} \\ {h}_{1 , 2}^{H} {f}_{2}\end{matrix} ] {s}_{2} + [ \begin{matrix}{h}_{2 , 1}^{H} {f}_{3} \\ {h}_{2 , 2}^{H} {f}_{3}\end{matrix} ] {s}_{3} + n \qquad ( 2 )$$

Where n∈C^{N}^{ᵣ}^{×1} is thermal noise.

### 2. Problems of Existing MU-MIMO Channel Feedback Methods

According to the NR standard specification TS 38.214, the number of columns of the channel feedback matrix of MU-MIMO in the existing standard is the number of data layers, and the number of rows is the number of transmitting antenna ports. In the model shown in FIG. 1, the UE 1 needs to feed back the channel matrix of column v to the base station 1 and the channel matrix of column v′ to the base station 2. However, since the channel matrix from two base stations to UE 1 is

$${H}_{1 , 1} ∈ {C}^{{N}_{r} \times {N}_{{t}_{1}}} and {H}_{2 , 1} ∈ {C}^{{N}_{r} \times {N}_{{t}_{2}}} ,$$

the number of rows of (H_{1,1})^{H} and (H_{2,1})^{H} is the number of transmitting antenna ports of the two base stations, but the number of columns is Nᵣ, and in general we have Nᵣ>v+v′. This indicates that the dimension of the channel matrix fed back according to the existing standard will be smaller than the actual channel matrix and cannot fully reflect the real MIMO channel.

In the case of a single base station in a non-NCJT scenario, the problem of such a feedback channel matrix can be solved by the UE selecting a merging matrix and converting the number of columns of the merged equivalent channel into the number of data layers. Specifically, for a UE with MU-MIMO, if the channel from the base station to the UE is H, and the number of data layers is v₀, then the number of columns of (H)^{H} is the number of the receiving antennas of the UE. The UE may select a merging matrix W of v₀ rows such that the merged WH equivalent channel matrix I is v₀ rows, i.e. (WH)^{H} is column v₀. After receiving the feedback equivalent channel matrix (WH)^{H} fed back by the UE, the base station can set the MU-MIMO pre-coding matrix so that the pre-coding vectors of other UEs served by the base station are orthogonal to WH, so that the UE will not suffer from interference from other UEs. Furthermore, the pre-coding matrix of the base station for this UE is denoted by F: the UE reserves a merging matrix WHF, and sets a second merging matrix W′ for the pre-coded and merged equivalent channel WHF so as to recover transmission data from the equivalent channel WHF (for example, W′ can be set as an inverse of WHF). At this time, the overall merging matrix of the UE can be represented by W′W.

However, in the NCJT scenario, the above solution has the problem that the merging matrix at the UE side cannot be set. Specifically, considering the system model shown in FIG. 1, a UE 1 as an NCJT UE can respectively select merging matrices W_{1,1} and W_{2,1} of v and v′ rows for H_{1,1} and H_{2,1}, so that a channel feedback matrix (W_{1,1}H_{1,1})^{H} is an v column matrix to be fed back to a base station 1, and a channel feedback matrix (W_{2,1}H_{2,1})^{H} is a v′ column matrix to be fed back to a base station 2. Upon receipt of (W_{1,1}H_{1,1})^{H} by the base station 1, the pre-coding matrix (i.e., Fₖ_{₁}, k₁=2, . . . , K₁) of the other UEs it serves may be set to be orthogonal to W_{1,1}H_{1,1}. Upon receipt of (W_{2,1}H_{2,1})^{H} by the base station 2, the pre-coding matrix (i.e., Fₖ_{₂}, k₂=K₁+1, . . . , K₁+K₂−1) of the other UEs it serves may be set to be orthogonal to W_{2,1}H_{2,1}. At this time, taking the overall merging matrix of the UE 1 as W^{t}∈C^{(v+v′)×N}^{ᵣ}, the merged received signal can be represented by the following Formula (3):

$${W}^{t} y = {W}^{t} [ {H}_{1 , 1} {F}_{1} , {H}_{2 , 1} {F}_{1}^{′} ] [ \begin{matrix}{s}_{1} \\ {s}_{1}^{′}\end{matrix} ] + {\sum }_{{k}_{1} = 2}^{{K}_{1}} {W}^{t} {H}_{1 , 1} {F}_{{k}_{1}} {s}_{{k}_{1}} + {\sum }_{{k}_{2} = {K}_{1} + 1}^{{K}_{1} + {K}_{2} - 1} {W}^{t} {H}_{2 , 1} {F}_{{k}_{2}} {s}_{{k}_{2}} + {W}^{t} \qquad ( 3 )$$

Note that base station 1 can only guarantee that Fₖ_{₁} is orthogonal to W_{1,1}H_{1,1}, so in order to ensure that other UEs of base station 1 do not interfere with UE 1, the row space of W^{t} must be included in the row space of W_{1,1}, which results in a rank of W^{t} being at most v. However, in order to support NCJT of v+v′ layer data, the rank of the merged equivalent channel W^{t}[H_{1,1}F₁,H_{2,1}F₁′] needs to be v+v′, but the rank of W^{t} is only v at maximum, which cannot meet this requirement. This results in the UE 1 not being able to set W^{t} to be able to both ensure that other UEs of the base station 1 do not interfere with themselves and to recover the v+v′ layer data. By the same reasoning, the UE 1 cannot set W^{t} to ensure that other UEs of the base station 2 do not interfere with themselves and can recover v+v′ layer data.

More specifically, taking the relatively simple system model shown in FIG. 2 as an example, the channel matrix fed back by UE 1 to base station 1 may be denoted by w₁h_{1,1}+w₂h_{1,2}, the channel matrix fed back by UE 1 to base station 2 may be denoted by w′₁h_{2,1}+w′₂h_{2,2}, the channel matrix fed back by UE 2 to base station 1 may be denoted by h₂, and the channel matrix fed back by UE 3 to base station 2 may be denoted by h₃.

According to Formulas (2) and (3), the received signal after being merged in this model can be represented by the following Formula (4):

$$\hat{y} = W y = W [ \begin{matrix}{h}_{1 , 1}^{H} {f}_{1} & {h}_{2 , 1}^{H} {{f}^{′}}_{1} \\ {h}_{1 , 2}^{H} {f}_{1} & {h}_{2 , 2}^{H} {{f}^{′}}_{1}\end{matrix} ] [ \begin{matrix}{s}_{1} \\ {{s}^{′}}_{1}\end{matrix} ] + W [ \begin{matrix}{h}_{1 , 1}^{H} {f}_{2} \\ {h}_{1 , 2}^{H} {f}_{2}\end{matrix} ] {s}_{2} + W [ \begin{matrix}{h}_{2 , 1}^{H} {f}_{3} \\ {h}_{2 , 2}^{H} {f}_{3}\end{matrix} ] {s}_{3} + Wn \qquad ( 4 )$$

Furthermore, it can be seen from Formula (4) that in order to be able to separate the two layers of data s₁ and s′₁, we expect that:

$$W [ \begin{matrix}{h}_{1 , 1}^{H} {f}_{1} & {h}_{2 , 1}^{H} {{f}^{′}}_{1} \\ {h}_{1 , 2}^{H} {f}_{1} & {h}_{2 , 2}^{H} {{f}^{′}}_{1}\end{matrix} ] = [ \begin{matrix}{λ}_{1} & 0 \\ 0 & {{λ}^{′}}_{1}\end{matrix} ]$$

(i.e. it can be expressed as a diagonal matrix)

At the same time, in order to cancel the interference from the UE 2, W must satisfy:

$$W = [ \begin{matrix}{w}_{1}^{*} & {w}_{2}^{*} \\ {w}_{1}^{*} & {w}_{2}^{*}\end{matrix} ]$$

eliminating interference from UE 3, W must satisfy:

$$W = [ \begin{matrix}{w}_{1}^{′ *} & {w}_{2}^{′ *} \\ {w}_{1}^{′ *} & {w}_{2}^{′ *}\end{matrix} ]$$

Therefore, with the existing channel feedback method, it is obvious that W cannot be set to be able to separate out s₁ and s′₁ and to cancel interference from UE 2 and UE 3.

### 3. A Channel Feedback Method According to an Embodiment of the Present Invention

In order to solve the above problem of the MU-MIMO UE merging matrix in the NCJT scenario, we can improve the channel feedback of NCJT UE to base station 1 and base station 2.

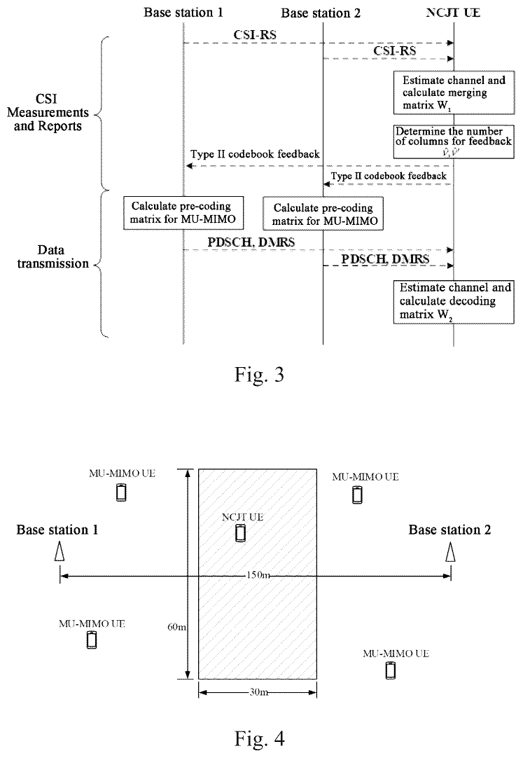

FIG. 3 is a flowchart illustrating a channel feedback method according to an embodiment of the present invention. It should be understood that the channel feedback method according to an embodiment of the present invention includes a method for performing channel feedback to a base station at a user side and a method for processing received channel feedback at a base station side, which will be described as the channel feedback method according to an embodiment of the present invention in the whole signaling flow shown in FIG. 3 in the description process for easy reading and understanding.

First, at the UE 1 side, the UE 1 receives channel state information reference signals (CSI-RSs) from the base station 1 and the base station 2, and then calculates an equivalent channel matrix of the channel from the base station 1 to the UE 1 and an equivalent channel matrix of the channel from the base station 2 to the UE 1 based on the CSI-RSs from the base station 1 and the base station 2, respectively. The process of calculating the equivalent channel matrix includes obtaining a channel matrix based on the CSI-RS, and then calculating a merging matrix, which will be described in detail later. UE 1 feeds back the feedback equivalent channel matrix to base station 1 (type II codebook feedback) based on the calculated equivalent channel matrix from base station 1 to UE 1, and feeds back the feedback equivalent channel matrix to base station 2 (type II codebook feedback) based on the calculated equivalent channel matrix from base station 2 to UE 1.

Through the above steps, measurement and reporting of channel state information (CSI) are completed at UE 1 side, and then data transmission is started to determine a decoding matrix. At the base station side, the base station 1 calculates a pre-coding matrix F₁ based on the received feedback equivalent channel matrix, and transmits the data demodulation reference signal (DM-RS) pre-coded by F₁ and UE data to the UE 1 via a downlink data channel (PDSCH); the base station 2 calculates a pre-coding matrix F₂ based on the received feedback equivalent channel matrix, and transmits the data demodulation reference signal (DM-RS) pre-coded by F₂ to the UE 1 via a downlink data channel (PDSCH). The pre-coding matrix F₁ and the pre-coding matrix F₂ are used to avoid interference of signals of other users UE 1 served by base station 1 and base station 2.

Then, at the UE 1 side, the UE 1 calculates a decoding matrix W₂ based on the first data demodulation reference signal and the second data demodulation reference signal, and the UE 1 can recover data from the base station 1 and the base station 2 based on the decoding matrix W₂. By setting the number of columns of a feedback equivalent channel matrix fed back by the UE 1 to the base station 1 and the base station 2 to be equal to or less than the sum of the number of data layers of the base station 1 and the number of data layers of the base station 2, and determining a pre-coding matrix based on such a feedback equivalent channel matrix, it is possible to achieve both separating signals of each layer and eliminating interference from other users.

Hereinafter, such a channel feedback method will be described in detail.

### 3.1 Schematic Illustration of a Channel Feedback Method According to an Embodiment of the Present Invention

Still referring to the system model shown in FIG. 1, in a channel feedback method according to an embodiment of the present invention, after a UE 1 measures a CSI-RS to obtain H_{1,1} and H_{2,1} of a base station 1 and a base station 2, instead of respectively calculating merging matrices W_{1,1} and W_{2,1} for the base station 1 and the base station 2 respectively having v and v′ rows, a common merging matrix W₁∈C^{(v+w)×N}^{ᵣ} is calculated, thereby feeding back a channel matrix (W₁H_{1,1})^{H} of v+v′ columns to the base station 1 and feeding back a channel matrix (W₁H_{2,1})^{H} of v+v′ columns to the base station 2. Then, base station 1 may set the pre-coding matrix F₁∈C^{N}^{ₜ}^{×v} and Fₖ_{₁}, such that Fₖ_{₁} (k₁=2, . . . , K₁) is orthogonal to W₁H_{1,1}, and base station 2 may set F₂∈C^{N}^{ₜ}^{×v′} and Fₖ_{₂}, such that Fₖ_{₂} (k₂=K₁+1, . . . , K₁+K₂−1) is orthogonal to W₁H_{2,1}.

Thus, since the pre-coding matrices Fₖ_{₁} of the other users served by the base station 1 are orthogonal to W₁H_{1,1} and the pre-coding matrices Fₖ_{₂} of the other users served by the base station 2 are orthogonal to W₁H_{2,1}, interference from UE 1 is eliminated as shown in the following Formula (5).

$${W}_{1} y = {W}_{1} [ {H}_{1 , 1} {F}_{1} , {H}_{2 , 1} {F}_{1}^{′} ] [ \begin{matrix}{s}_{1} \\ {{s}^{′}}_{1}\end{matrix} ] + {\sum }_{{k}_{1} = 2}^{{K}_{1}} {W}_{1} {H}_{1 , 1} {F}_{{k}_{1}} {s}_{{k}_{1}} + {\sum }_{{k}_{2} = {K}_{1} + 1}^{{K}_{1} + {K}_{2} - 1} {W}_{1} {H}_{2 , 1} {F}_{{k}_{2}} {s}_{{k}_{2}} + {W}_{1} n = {W}_{1} [ {H}_{1 , 1} {F}_{1} , {H}_{2 , 1} {F}_{1}^{′} ] [ \begin{matrix}{s}_{1} \\ {{s}^{′}}_{1}\end{matrix} ] + {W}_{1} n \qquad ( 5 )$$

In the above-mentioned process that the UE 1 calculates the equivalent channel matrix (W₁H_{1,1})^{H} of the channel from the base station 1 to the UE 1 and the equivalent channel matrix (W₁H_{2,1})^{H} of the channel from the base station 2 to the UE 1 based on the CSI-RSs from the base station 1 and the base station 2, respectively, W₁ and W₂ can be set by the UE 1 as specified by the specification. With regard to the setting of W₁, for example, UE 1 may perform singular value decomposition on the channel matrices from two base stations to UE 1, denoted by [H_{1,1},H_{2,1}]=UΣV^{H}, wherein E is a diagonal matrix, the diagonal elements of which are singular values of [H_{1,1},H_{2,1}], and are arranged in an order from large to small from top left to bottom right. Thus, W₁ can be taken to be a conjugate transpose matrix of the matrix formed by the first v+v′ columns of U (i.e. the first v+v′ left singular vectors of [H_{1,1},H_{2,1}]). Alternatively, in order to reduce the calculation amount, W₁ can also be set as a selection matrix of v+v′ rows and v+v′ columns, for example, the merging matrix W₁ corresponding to the UE 1 selecting the first v+v′ receiving antennas from Nᵣ receiving antennas can be represented by:

$$[ \begin{matrix}{I}_{v + v ′} & 0\end{matrix} ]$$

where I_{v+v′}, is a v+v′ order unit matrix.

It is to be understood that the several methods for setting W₁ illustrated above are merely exemplary and that one skilled in the art can set the merging matrix W₁ in any suitable manner known in the art depending on the requirements and the actual situation.

Next, after setting the pre-coding matrix, the base station 1 simultaneously transmits the pre-coded DM-RS by transmitting the pre-coded UE data on the PDSCH. After receiving the above information, UE 1 estimates a pre-coded channel matrix according to the DM-RS and calculates a decoding matrix W₂ to demodulate data from two base stations. That is, the UE 1 can recover s₁ and s₁′ from the equivalent channel W₁[H_{1,1}F₁,H_{2,1}F₁′] by setting the decoding matrix W₂. The resulting whole merging matrix can be represented by W₂W₁.

For the specific setting of W₂, at the UE 1 side, the setting can be made as needed for the equivalent channel W₁[H_{1,1}F₁,H_{2,1}F₁′] using any suitable algorithm criteria known in the art, such as zero-forcing algorithm, LS algorithm, MMSE algorithm, LMMSE algorithm, etc. For example, if a zero-forcing algorithm is used, W₂ can be designed as an inverse of W₁[H_{1,1}F₁,H_{2,1}F₁′]. Alternatively, if the MMSE algorithm is used, H^{eff}=W₁[H_{1,1}F₁,H_{2,1}F₁′] can be set, and W₂ can be represented by the following Formula (6):

$${( {( {H}^{eff} )}^{H} {H}^{eff} + \frac{{P}_{n}}{{P}_{s}} {I}_{v + v ′} )}^{- 1} \qquad ( 6 )$$

where Pₛ, Pₙ is the power of the transmitted signal and the receiver noise, respectively.

It should be noted that although it is mentioned above that the channel matrix (W₁H_{1,1})^{H} fed back to the base station 1 is column v+v′ and the channel matrix (W₁H_{2,1})^{H} fed back to the base station 2 is column v+v′, the actual channel of the base station to the UE 1 itself may not be full-rank. For example, the channel may be under-rank when propagating LOS between the base station and UE 1. In this case, (W₁H_{1,1})^{H} and (W₁H_{2,1})^{H} fed back from UE 1 to base station 1 and base station 2 may also not be full-rank, i.e., rank less than v+v′. On the other hand, since the base station 1 has been set to transmit v layer data to the UE 1, it is indicated that the rank of (W₁H_{1,1})^{H} is at least v. It can be seen therefrom that in the case where the channel of the base station 1 to the UE 1 is under-rank, the range of the rank of (W₁H_{1,1})^{H} can be from v to v+v′. Therefore, in order to ensure that Fₖ_{₁} (k₁=2, . . . , K₁) is orthogonal to W₁H_{1,1}, the UE 1 does not need to feed back the complete (W₁H_{1,1})^{H}, but only the channel matrix whose column space is equivalent to the column space of (W₁H_{1,1})^{H} to the base station 1 and the number of columns of the fed back matrix is (W₁H_{1,1})^{H}. In other words, the equivalent channel matrix of the actual feedback only needs to be the same as the column space of (W₁H_{1,1})^{H}. By the same reasoning, the UE 1 only needs to feed back a channel matrix whose column space is equivalent to the column space of (W₁H_{2,1})^{H} to the base station 2 and the number of columns of the feedback matrix is (W₁H_{2,1})^{H}.

It can be seen from the above that in a channel feedback method according to an embodiment of the present invention, UE 1 can feed back \hat{v}∈{v, . . . , v+v′} columns of feedback channel matrices to base station 1, and UE 1 can feed back \hat{v}′∈{v′, . . . , v+v′} columns of feedback channel matrices to base station 2, wherein the specific values of \hat{v} and \hat{v}′ can be determined according to the ranks of the two feedback channel matrices. In other words, in the channel feedback method according to an embodiment of the present invention, the UE 1 can elastically determine the number of columns of the feedback channel matrix actually fed back according to the rank of the feedback channel matrix.

In implementation, for example, UE 1 may perform a singular value decomposition on (W₁H_{1,1})^{H}, denoted by (W₁H_{1,1})^{H}=UΣV^{H}, where Σ is a diagonal matrix whose diagonal elements are the singular values of (W₁H_{1,1})^{H}, arranged in order from top left to bottom right from large to small. If the actual rank of (W₁H_{1,1})^{H} is 0, it can be considered that the first \hat{v}^{\hat{ }} of Σ is non-zero, and the remaining diagonal elements are close to zero. Therefore, the column space of (W₁H_{1,1})^{H} can be represented by the first \hat{v}^{\hat{ }} columns of U, i.e., the first \hat{v}^{\hat{ }} left singular vectors of (W₁H_{1,1})^{H}, so the UE 1 can feed back a matrix composed of the first \hat{v}^{\hat{ }} left singular vectors of (W₁H_{1,1})^{H} to the base station 1. Similarly, the UE 1 can feed back to the base station 2 a matrix formed by the first \hat{v}′ left singular vectors of (W₁H_{2,1})^{H}, where \hat{v}′ is the rank of (W₁H_{2,1})^{H}.

### 3.2 Simulation Results of a Channel Feedback Method According to an Embodiment of the Present Invention

In order to verify the performance and effect of the channel feedback method according to an embodiment of the present invention, the inventors performed simulation experiments thereon. Setting of simulation scenario as shown in FIG. 4, base station 1 and base station 2 are 150 m apart, and NCJT UE is randomly distributed in a rectangular area of 60 m×30 m located in the middle of two base stations. In other words, the NCJT UE is located in a border area of two adjacent cells. In addition, two base stations each serve two local MU-MIMO UEs. Both the base station 1 and the base station 2 use MU-MIMO serving 3 UEs on the same frequency at the same time to provide a layer 1 data stream for each UE. The base station has a height of 20 m, four transmit antennas or four transmitting antenna ports (i.e., Nₜ_{₁}=Nₜ_{₂}=4 Tx) are configured, and a block diagonal algorithm is used to calculate and determine the MU-MIMO pre-coding matrix. The NCJT UE has a height of 1.5 m and is equipped with 2 receiving antennas (i.e., Nᵣ=2 Rx). The remaining UE height is also 1.5 m with one receiving antenna (i.e., Nᵣ=1 Rx). In addition, a carrier frequency of 3 GHZ, a noise power spectral density of −174 dB/Hz, and a system bandwidth of 25 MHz were set. The simulation models the channel from the base station to the user using a Rician channel model, and the channel matrix can be represented by Formula (7):

$$H = \sqrt{\frac{K}{K + 1}} {H}_{L O S} + \sqrt{\frac{1}{K + 1}} {H}_{N L O S} \qquad ( 7 )$$

Where H_{LOS} is a direct path of a channel, H_{NLOS} is a non-direct path, and K is a Rician factor for representing the ratio of the energy of the line-of-sight transmission part and the non-line-of-sight transmission part of the channel. When K is large, the channel is dominated by the direct path, usually under-rank. When K is small (approaching zero), the channel is dominated by the non-direct path, and the channel is typically full-rank.

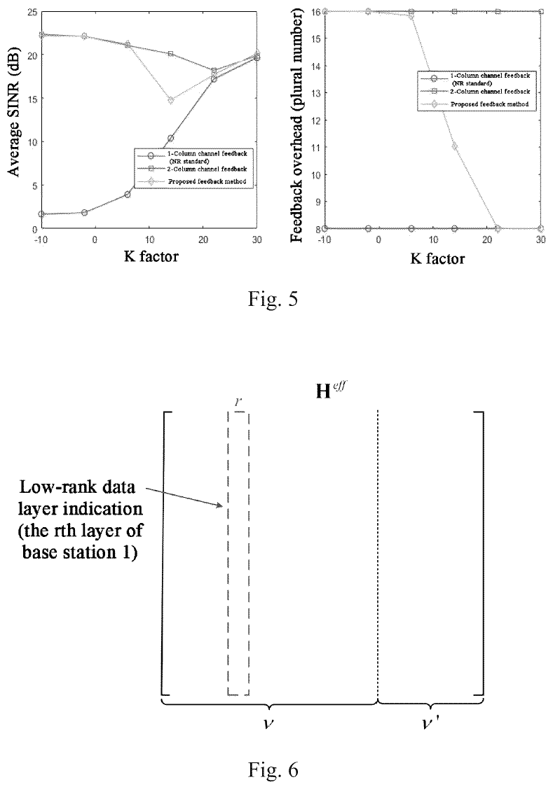

Note that the conjugate transpose matrix of the channel matrices from base station 1 and base station 2 to the NCJT UE are both two columns and the number of data layers transmitted is 1. According to the proposed feedback method, NCJT UE can decide to feedback a feedback channel matrix of 1 column to 2 columns to base station 1 and base station 2 according to the rank of the merged equivalent channel matrix. Meanwhile, according to the NR standard, since the number of data layers from both base stations to the NCJT UE is 1, the NCJT UE should feed back a channel matrix of 1 column to both base stations. The simulation results of simulating the average SINR and the amount of feedback required for the two-layer data for NCJT UE at different Rician factors K are shown in FIG. 5. As can be seen from the graph of FIG. 5, the proposed feedback method achieves a significant SINR gain when K is small compared to the 1-column feedback in the NR standard. This is because when K is small, the rank of the channel matrix is 2, feeding back only 1 column of channels will cause channel information to be lost. Meanwhile, the average SINR of the feedback method according to an embodiment of the present invention is similar to that of the full channel feedback of 2 columns, and the feedback overhead of the feedback method according to an embodiment of the present invention can be significantly reduced when K is large. It can be seen therefrom that the feedback method according to an embodiment of the present invention achieves a good compromise between communication performance and feedback overhead.

### 4. A Pre-Coding Matrix Adjustment Method According to an Embodiment of the Present Invention

In the MU-MIMO system in the NCJT scenario, in addition to the above-mentioned problem of channel feedback at the UE side, the following problem may also exist at the base station side: since the pre-coding matrices for NCJT UE for each base station are calculated and determined independently of each other, this results in that the overall channel matrix from base station to NCJT UE may be under-rank after being pre-coded.

The following describes a pre-coding matrix adjustment method according to an embodiment of the present invention based on the MU-MIMO system in the NCJT scenario as shown in FIG. 1. For example, the merged received signal model in Formula (5) above is as an example:

$${W}_{1} y = {W}_{1} [ {H}_{1 , 1} {F}_{1} , {H}_{2 , 1} {F}_{1}^{′} ] [ \begin{matrix}{s}_{1} \\ {{s}^{′}}_{1}\end{matrix} ] + {W}_{1} n$$

Here, for the convenience of explanation, it is assumed that interference from other UEs has been canceled by the channel feedback method proposed above to be pre-coded by the base station MU-MIMO (it should be understood that the pre-coding matrix adjustment method according to an embodiment of the present invention is still effective even if the interference of other UEs is not canceled). At this time, the pre-coded equivalent channels from the base station 1 and the base station 2 to the NCJT UE are W₁[H_{1,1}F₁,H_{2,1}F₁′]. Since the setting of F₁ and F₁ is performed by the base station 1 and the base station 2 independently from each other, it is possible to cause W₁[H_{1,1}F₁,H_{2,1}F₁′] to be rank-deficient, thereby failing to support v+v′ layer data transmission. To solve the above problem, the present invention further proposes a pre-coding adjustment method based on UE feedback. By receiving the DM-RS transmitted by the two base stations, UE 1 measures the merged equivalent channel W₁[H_{1,1}F₁,H_{2,1}F₁′]. UE 1 then detects whether W₁[H_{1,1}F₁,H_{2,1}F₁′] is full-rank. In other words, the UE 1 concatenates the pre-coded equivalent channel matrix of the base station 1 and the pre-coded equivalent channel matrix of the base station 2, and detects whether the concatenated matrix is under-rank. If W₁[H_{1,1}F₁,H_{2,1}F₁′] is not column full rank, NCJT UE further detects columns in W₁[H_{1,1}F₁,H_{2,1}F₁′] that can be approximately linearly represented by the remaining columns. For example, NCJT UE may compute a projection of each column of W₁[H_{1,1}F₁,H_{2,1}F₁′] into a linear space of the remaining columns column by column, and if the projection vector norm of a column is large, the column may be considered to be approximately linearly represented by the remaining columns.

If the NCJT UE detects that a certain column among W₁[H_{1,1}F₁,H_{2,1}F₁′] can be approximately linearly represented by the remaining columns, it indicates that the pre-coding vector of the data layer corresponding to the column needs to be adjusted, and the UE can feed back a low-rank data layer indication information to the base station 1 or the base station 2 so as to indicate that the pre-coding vector of a certain layer of the corresponding base station needs to be adjusted. FIG. 6 gives an example of a low-rank data layer indication. As shown in FIG. 6, this indication should be fed back to the base station 1 and indicate that the pre-coding vector of the r^{th} layer data needs to be adjusted, i.e. the r^{th} column of F₁.

An implementation example of the base station adjusting the pre-coding vector is given below based on the MU-MIMO system in the NCJT scenario shown in FIG. 1. Taking the adjustment of the r^{th} column of the pre-coding matrix F₁ of the base station 1 as an example, it is considered that the base station 1 adopts diagonal-based MU-MIMO pre-coding algorithm. In order that the signal of the UE 1 does not cause interference to other UEs served by the base station 1, the F₁ should be orthogonal to the channels of the other UEs, and therefore the F₁ can be considered to belong to a linear space orthogonal to the channels of the other UEs, which can be written as a column space of a matrix V₁ (corresponding to a first orthogonal matrix in the present invention), and thus each column of the F₁ can be represented by a linear combination of the columns of the V₁. Thus, F₁ can be represented by the following Formula (8):

$${F}_{1} = {V}_{1} [ {\tilde{f}}_{1} , … , {\tilde{f}}_{v} ] \qquad ( 8 )$$

It can be seen therefrom that the base station 1 only needs to determine \tilde{f}₁, . . . , \tilde{f}ᵥ. In a block diagonal pre-coding algorithm, in order to obtain an optimal channel capacity, \tilde{f}₁, . . . , \tilde{f}v can be selected as the first v right singular vectors of matrices W₁H_{1,1}V₁ (corresponding to a first block diagonal pre-coding matrix in the present invention). In this case, in order to adjust the r^{th} column of F₁, the old \tilde{f}ᵣ is simply replaced by the (v+1)^{th} right singular vector. More generally, in order to adjust \tilde{f}ᵣ, it is only necessary to replace it with a right singular vector of W₁H_{1,1}V₁ that is not currently selected by \tilde{f}₁, . . . , \tilde{f}ᵥ. Note that the value of the old \tilde{f}ᵣ is \tilde{f}ᵣ^{old}, and the adjusted value is \tilde{f}ᵣ^{new}, then the equivalent channel of the r^{th} layer data of the base station 1 before the adjustment is W₁H_{1,1}V₁\tilde{f}ᵣ^{old}, and the equivalent channel of the r^{th} layer data of the base station 1 after the adjustment is W₁H_{1,1}V₁\tilde{f}ᵣ^{new}. Note that the inner product of the equivalent channels before and after adjustment can be represented by Formula (9):

$${( {W}_{1} {H}_{1 , 1} {V}_{1} {\tilde{f}}_{r}^{o l d} )}^{H} ( {W}_{1} {H}_{1 , 1} {V}_{1} {\tilde{f}}_{r}^{n e w} ) = {( {\tilde{f}}_{r}^{o l d} )}^{H} {( {W}_{1} {H}_{1 , 1} {V}_{1} )}^{H} ( {W}_{1} {H}_{1 , 1} {V}_{1} ) {\tilde{f}}_{r}^{n e w} = {( {\tilde{f}}_{r}^{o l d} )}^{H} {( {σ}_{r}^{n e w} )}^{2} {\tilde{f}}_{r}^{n e w} = 0 \qquad ( 9 )$$

In the above equation (9), since \tilde{f}ᵣ^{new} is the right singular vector of W₁H_{1,1}V₁, it is also the eigenvector of (W₁H_{1,1}V₁)^{H}(W₁H_{1,1}V₁), so (W₁H_{1,1}V₁)^{H}(W₁H_{1,1}V₁) can remember its corresponding eigenvalue as (σᵣ^{new})². In addition, since \tilde{f}ᵣ^{old} and \tilde{f}ᵣ^{new} are both right singular vectors of W₁H_{1,1}V₁, they are orthogonal, so the inner product of equivalent channels before and after adjustment is zero. The above formula shows that the adjusted equivalent channel is orthogonal to the adjusted equivalent channel. Therefore, the pre-coding adjustment scheme according to an embodiment of the present invention can effectively change the equivalent channel to solve the problem that the equivalent channel is under-rank due to the improper pre-coding matrix.

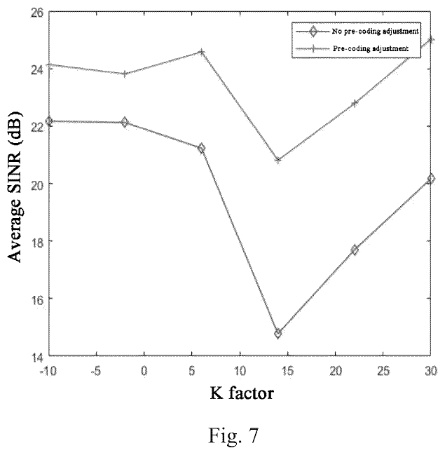

Based on the previously proposed feedback scheme, the present invention simulates the effect of the proposed pre-coding adjustment scheme, as shown in FIG. 7. Simulation parameters and scenarios still follow the configuration under the simulation scenarios described above. When the channel matrix is found to be under-rank, the NCJT UE feeds back a low-rank data layer indication to the base station 1 or the base station 2, and a corresponding base station adjusts a pre-coding vector after receiving the indication information. It can be seen from FIG. 7 that after adjustment, the average SINR of NCJT UE two-layer data is significantly improved, thereby verifying the beneficial effect of the pre-coding adjustment scheme proposed according to an embodiment of the present invention.

### 5. A Variant of the Channel Feedback Method According to an Embodiment of the Present Invention

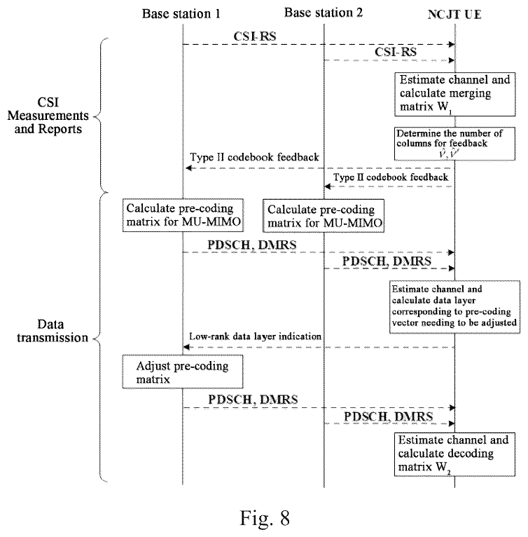

In the foregoing, a channel feedback method and a pre-coding adjustment method according to an embodiment of the present invention have been described, respectively. Further, the channel feedback method according to an embodiment of the present invention may be used in conjunction with the pre-coding adjustment method described above. A signaling flow of a variant of the channel feedback method according to an embodiment of the present invention is shown in FIG. 8. It can be seen from FIG. 8 that, in the channel feedback method according to a variant of the present invention, the steps from the initial step up to the steps that the base station 1 and the base station 2 respectively calculate pre-coding matrices F₁ and F₂ based on the received feedback equivalent channel matrix and respectively transmit the pre-coded DM-RS to the UE 1 via the PDSCH are the same as the steps in the above-described embodiment. Then, UE 1 can obtain the equivalent channel W₁[H_{1,1}F₁,H_{2,1}F₁′] from the base station to UE 1 through DM-RS estimation, and detect whether there is a pre-coding vector corresponding to a certain layer of data of a certain base station to be adjusted through the method which has been described in detail above. Illustrated in FIG. 8 is the case where it is detected that a certain column of the pre-coding matrix of the base station 1 needs to be adjusted. At this time, the UE 1 transmits a low-rank data layer indication to the base station 1, and after receiving the indication, the base station 1 adjusts a column vector of a corresponding column of a pre-coding matrix, for example, by the method described in detail above, and uses the adjusted pre-coding matrix to transmit the PDSCH and the DM-RS to the UE 1 again. Then, after receiving the above-mentioned information, UE 1 estimates a pre-coded channel matrix according to the adjusted pre-coding matrix and calculates a decoding matrix W₂ to demodulate data from two base stations.

Note that the above-described embodiments and variants describe examples for implementing the present technology, respectively, and the subject matter in the embodiment has a correspondence with the present invention of the subject matter defined in the claims. However, the present technology is not limited to the embodiments and modifications, and may be implemented by various modifications of the embodiments without departing from the spirit of the present technology.

It should be noted that the effects described herein are merely examples and are not limiting, and that other effects may be produced.

It should be noted that the present techniques may be implemented as follows.

### (1) A Method for Channel Feedback at a User Side Under Non-Coherent Joint Transmission, Wherein the Method Comprises the Following Steps:

S1: receiving, by a joint transmission user, a first channel state information reference signal from a first base station, and receiving a second channel state information reference signal from a second base station;
S2: calculating, by the joint transmission user, a first equivalent channel matrix from the first base station to a first channel of the joint transmission user based on the first channel state information reference signal, and calculating a second equivalent channel matrix from the second base station to a second channel of the joint transmission user based on the second channel state information reference signal;
S3: feeding back, by the joint transmission user, a first feedback equivalent channel matrix to the first base station based on the first equivalent channel matrix, and feeding back a second feedback equivalent channel matrix to the second base station based on the second equivalent channel matrix; and
S5: receiving, by the joint transmission user, a first data demodulation reference signal pre-coded by a first pre-coding matrix from the first base station and a second data demodulation reference signal pre-coded by a second pre-coding matrix from the second base station, then calculating, by the joint transmission user, a decoding matrix based on the first data demodulation reference signal and the second data demodulation reference signal, wherein the joint transmission user can decode data from the first base station and the second base station based on the decoding matrix;
wherein the number of columns of the first feedback equivalent channel matrix and the number of columns of the second equivalent channel matrix are both equal to or less than the sum of the number of data layers of the first base station and the number of data layers of the second base station.
   (2)

The method according to (1), wherein in the S3, the first feedback equivalent channel matrix has the same column space as a conjugate transpose matrix of the first equivalent channel matrix, and the second feedback equivalent channel matrix has the same column space as a conjugate transpose matrix of the second equivalent channel matrix.

(3)

The method according to (2), wherein the joint transmission user sets the number of columns of the first feedback equivalent channel matrix to a rank of the first equivalent channel matrix and sets the number of columns of the second feedback equivalent channel matrix to a rank of the second equivalent channel matrix.

(4)

The method according to (3), wherein the rank of the first equivalent channel matrix is v, and the joint transmission user performs singular value decomposition on the conjugate transpose matrix of the first equivalent channel matrix, and sets the first feedback equivalent channel matrix as a channel matrix composed of the first \hat{v} left singular vectors of the left singular vector matrix obtained after singular value decomposition; and
the rank of the second equivalent channel matrix is \hat{v}′, and the joint transmission user performs singular value decomposition on the conjugate transpose matrix of the second equivalent channel matrix, and sets the second feedback equivalent channel matrix as a channel matrix composed of the first v′ left singular vectors of the left singular vector matrix obtained after singular value decomposition.
   (5)

The method according to (1), wherein in the S3, the joint transmission user feeds back a first feedback equivalent channel matrix to the first base station, so that the first base station calculates the first pre-coding matrix based on the first feedback equivalent channel matrix; and the joint transmission user feeds back a second feedback equivalent channel matrix to the second base station, so that the second base station calculates the second pre-coding matrix based on the second feedback equivalent channel matrix,
wherein the first pre-coding matrix and the second pre-coding matrix are used for avoiding interference on a signal of the joint transmission user from other users served by the first base station and the second base station.
   (6)

The method according to (5), wherein the first pre-coding matrix is orthogonal to channels of users other than the joint transmission user served by the first base station and the second pre-coding matrix is orthogonal to the channels of users other than the joint transmission user served by the second base station.

(7)

The method according to any one of (1) to (6), wherein in the S2, the joint transmission user calculates a first channel matrix of the first channel based on the first channel state information reference signal and a second channel matrix of the second channel based on the second channel state information reference signal, and then the joint transmission user calculates a merging matrix based on the first channel matrix and the second channel matrix, the first equivalent channel matrix is a matrix obtained after the first channel matrix and the merging matrix are merged, and the second equivalent channel matrix is a matrix obtained after the second channel matrix and the merging matrix are merged.

(8)

The method according to (7), wherein the number of data layers transmitted by the first channel is v, the number of data layers transmitted by the second channel is v′, the number of receiving antennas of the joint transmission user is Nᵣ, and the merging matrix is W₁, satisfying W₁∈C^{(v+v′)×N}^{ᵣ}.

(9)

The method according to (8), wherein the joint transmission user concatenates the first channel matrix and the second channel matrix, and performs singular value decomposition on the concatenated matrix to obtain the merging matrix, wherein
the merging matrix is a conjugate transpose matrix of a sub-matrix composed of the first v+v′ columns of a left singular vector matrix obtained after decomposition;
or, the merging matrix is a selection matrix having v+v′ rows and a number of columns equal to the number of the receiving antennas of the joint transmission user.
   (10)

The method according to (7), wherein in the S5, the merging matrix is W₁, the first channel matrix is H_{1,1}, the first pre-coding matrix is F₁, the second channel matrix is H_{2,1}, the second pre-coding matrix is F′1, and the joint transmission user sets the decoding matrix W₂ to an inverse of W₁[H_{1,1}F₁,H_{2,1}F₁′].

(11)

The method according to any one of (1) to (6), further comprising S4 between the S3 and the S5: detecting, by the joint transmission user, whether a concatenated matrix of the pre-coded first equivalent channel matrix and the second equivalent channel matrix is under-rank according to the first data demodulation reference signal and the second data demodulation reference signal; if it is not under-rank, proceed to the S5;
if it is under-rank, the joint transmission user feeds back to the corresponding first base station and/or second base station an indication information indicating a target pre-coding vector needing to be adjusted of the first pre-coding matrix and/or the second pre-coding matrix, so that the first base station and/or the second base station adjust the target pre-coding vector after receiving the indication information and obtain a modified first pre-coding matrix and/or a modified second pre-coding matrix, and enable the first base station and/or the second base station to transmit the first data demodulation reference signal and/or the second data demodulation reference signal pre-coded by the modified first pre-coding matrix and/or the modified second pre-coding matrix back to the joint transmission user.
   (12)

The method according to (11), wherein in the S4, the joint transmission user checks column by column that whether or not each column of the pre-coded first equivalent channel matrix and the pre-coded second equivalent channel matrix can be linearly represented by the remaining columns approximatively, and if at least one column can be linearly represented by the remaining columns approximatively, it is determined that it is under-rank, and the pre-coding vector of the corresponding column in the first pre-coding matrix and/or the second pre-coding matrix is determined as the target pre-coding vector needing to be adjusted.

(13)

A wireless communication device, wherein the wireless communication device can perform channel feedback with a base station using the method according to any one of (1) to (12) under non-coherent joint transmission.

(14)

A method for processing channel feedback at a base station side under non-coherent joint transmission, wherein the method comprises the following steps:
S1: transmitting, by a first base station, a first channel state information reference signal to a joint transmission user, so that the joint transmission user calculates a first equivalent channel matrix of a first channel from the first base station to the joint transmission user based on the first channel state information reference signal; and transmitting, by a second base station, a second channel state information reference signal to the joint transmission user, so that the joint transmission user calculates a second equivalent channel matrix of a second channel from the second base station to the joint transmission user based on the second channel state information reference signal;
S2: receiving, by the first base station, a first feedback equivalent channel matrix based on the first equivalent channel matrix feedback from the joint transmission user, and receiving, by the second base station, a second feedback equivalent channel matrix based on the second equivalent channel matrix feedback from the joint transmission user;
S3: calculating, by the first base station, a first pre-coding matrix based on the first feedback equivalent channel matrix, and transmitting a first data demodulation reference signal pre-coded by the first pre-coding matrix to the joint transmission user; calculating, by the second base station, a second pre-coding matrix based on the second feedback equivalent channel matrix, and transmitting a second data demodulation reference signal pre-coded by the second pre-coding matrix to the joint transmission user, wherein the first pre-coding matrix and the second pre-coding matrix are used for avoiding interference on a signal of the joint transmission user from other users served by the first base station and the second base station;
wherein the number of columns of the first feedback equivalent channel matrix and the number of columns of the second equivalent channel matrix are both equal to or less than the sum of the number of data layers of the first base station and the number of data layers of the second base station.
   (15)

The method according to (14), wherein in the S2, the first feedback equivalent channel matrix has the same column space as a conjugate transpose matrix of the first equivalent channel matrix, and the second feedback equivalent channel matrix has the same column space as a conjugate transpose matrix of the second equivalent channel matrix.

(16)

The method according to (15), wherein the number of columns of the first feedback equivalent channel matrix is set to a rank of the first equivalent channel matrix and the number of columns of the second feedback equivalent channel matrix is set to a rank of the second equivalent channel matrix.

(17)

The method according to (16), wherein the rank of the first equivalent channel matrix is v, and the first feedback equivalent channel matrix received by the first base station is a channel matrix as follows: the channel matrix is composed of the first \hat{v} left singular vectors of a left singular vector matrix obtained after singular value decomposition of the conjugate transpose matrix of the first equivalent channel matrix; and
the rank of the second equivalent channel matrix is \hat{v}′, and the second feedback equivalent channel matrix received by the second base station is a channel matrix as follows: the channel matrix is composed of the first \hat{v}′ left singular vectors of a left singular vector matrix obtained after singular value decomposition of the conjugate transpose matrix of the first equivalent channel matrix.
   (18)

The method according to (14), wherein in the S3, the first base station makes the first pre-coding matrix be orthogonal to channels of users other than the joint transmission user served by the first base station and the second base station makes the second pre-coding matrix be orthogonal to the channels of users other than the joint transmission user served by the second base station.

(19)

The method according to any one of (14) to (18), wherein after the S3, if a concatenated matrix of the first equivalent channel matrix pre-coded by the first pre-coding matrix and the second equivalent channel matrix pre-coded by a second pre-coding matrix is under-rank, the method further comprises the following step S4:
receiving, by the first base station and/or the second base station, indication information from the joint transmission user, the indication information indicating a target pre-coding vector of the first pre-coding matrix and/or the second pre-coding matrix needing to be adjusted, subsequently adjusting, by the first base station and/or the second base station, the target pre-coding vector and obtaining a modified first pre-coding matrix and/or a modified second pre-coding matrix, and transmitting the first data demodulation reference signal and/or the second data demodulation reference signal pre-coded by the modified first pre-coding matrix and/or the modified second pre-coding matrix to the joint transmission user.
   (20)

The method according to (19), wherein the modified first pre-coding matrix and/or the modified second pre-coding matrix are obtained by:
respectively replacing, by the first base station and/or the second base station, the target pre-coding vector needing to be adjusted in the first pre-coding matrix and/or the second pre-coding matrix with a right singular vector which is not currently used in a first block diagonal pre-coding matrix and/or a second block diagonal pre-coding matrix after the indication information is received;
wherein the first block diagonal pre-coding matrix/the second block diagonal pre-coding matrix is obtained by multiplying the first equivalent channel matrix/the second equivalent channel matrix with a first orthogonal matrix/a second orthogonal matrix, wherein the column space of the first orthogonal matrix is orthogonal to the channels of users other than the joint transmission user served by the first base station, and the column space of the second orthogonal matrix is orthogonal to the channels of users other than the joint transmission user served by the second base station, and a linear combination of columns in the first orthogonal matrix/the second orthogonal matrix can represent each column in the first pre-coding matrix/the second pre-coding matrix.
   (21)

The method according to (20), wherein after the indication information is received, the first base station and/or the second base station respectively replaces the target pre-coding vector needing to be adjusted in the first pre-coding matrix and/or the second pre-coding matrix with the (v+1)^{th} and/or the (v′+1)^{th} right singular vector in the first block diagonal pre-coding matrix and/or the second block diagonal pre-coding matrix, wherein v is the number of data layers transmitted by the first channel, and v′ is the number of data layers transmitted by the second channel.

(22)

The method according to any one of (14) to (21), wherein the first base station and the second base station do not share the transmitted data as well as channel state information of the first channel and the second channel to the joint transmission user.

(23)

A base station, wherein the base station can use the method according to any one of (14) to (22) to process channel feedback from a wireless communication device under non-coherent joint transmission.

(24)

A method for adjusting a pre-coding matrix at a base station side under non-coherent joint transmission, under the non-coherent joint transmission, a first base station transmitting data pre-coded by a first pre-coding matrix to a joint transmission user via a first channel, a second base station transmitting data pre-coded by a second pre-coding matrix to the joint transmission user via a second channel, the first channel having a first equivalent channel matrix, and the second channel having a second equivalent channel matrix,
wherein the method comprises the following steps:
S1: receiving, by the first base station and/or the second base station, indication information from the joint transmission user, and determining that the pre-coded first equivalent channel matrix and/or the second equivalent channel matrix are under-rank based on the indication information;
S2: adjusting, by the first base station and/or the second base station, the target pre-coding vector and obtaining a modified first pre-coding matrix and/or a modified second pre-coding matrix according to the target pre-coding vector needing to be adjusted of the first pre-coding matrix and/or the second pre-coding matrix indicated in the indication information, and transmitting the first data demodulation reference signal and/or the second data demodulation reference signal pre-coded by the modified first pre-coding matrix and/or the modified second pre-coding matrix to the joint transmission user.
   (25)

The method according to (24), wherein the modified first pre-coding matrix and/or the modified second pre-coding matrix are obtained by:
respectively replacing, by the first base station and/or the second base station, the target pre-coding vector needing to be adjusted in the first pre-coding matrix and/or the second pre-coding matrix with a right singular vector which is not currently used in a first block diagonal pre-coding matrix and/or a second block diagonal pre-coding matrix after the indication information is received;
wherein the first block diagonal pre-coding matrix/the second block diagonal pre-coding matrix is obtained by multiplying the first equivalent channel matrix/the second equivalent channel matrix with a first orthogonal matrix/a second orthogonal matrix, wherein the column space of the first orthogonal matrix is orthogonal to the channels of users other than the joint transmission user served by the first base station, and the column space of the second orthogonal matrix is orthogonal to the channels of users other than the joint transmission user served by the second base station, and a linear combination of columns in the first orthogonal matrix/the second orthogonal matrix can represent each column in the first pre-coding matrix/the second pre-coding matrix.
   (26)

The method according to (25), wherein after the indication information is received, the first base station and/or the second base station respectively replaces the target pre-coding vector needing to be adjusted in the first pre-coding matrix and/or the second pre-coding matrix with the (v+1)^{th} and/or the (v′+1)^{th} right singular vector in the first block diagonal pre-coding matrix and/or the second block diagonal pre-coding matrix, wherein v is the number of data layers transmitted by the first channel, and v′ is the number of data layers transmitted by the second channel.

(27)

The method according to any one of (24) to (26), wherein the first base station and the second base station do not share the transmitted data as well as channel state information of the first channel and the second channel to the joint transmission user.

(28)

A base station, wherein the base station can adjust a pre-coding matrix of a channel matrix for the base station to a joint transmission user under non-coherent joint transmission using the pre-coding matrix adjustment method according to any one of (24) to (27).

1. A method for channel feedback at a user side under non-coherent joint transmission, characterized in that, the method comprises the following steps:
S1: receiving, by a joint transmission user, a first channel state information reference signal from a first base station, and receiving a second channel state information reference signal from a second base station;
S2: calculating, by the joint transmission user, a first equivalent channel matrix from the first base station to a first channel of the joint transmission user based on the first channel state information reference signal, and calculating a second equivalent channel matrix from the second base station to a second channel of the joint transmission user based on the second channel state information reference signal;
S3: feeding back, by the joint transmission user, a first feedback equivalent channel matrix to the first base station based on the first equivalent channel matrix, and feeding back a second feedback equivalent channel matrix to the second base station based on the second equivalent channel matrix; and
S5: receiving, by the joint transmission user, a first data demodulation reference signal pre-coded by a first pre-coding matrix from the first base station and a second data demodulation reference signal pre-coded by a second pre-coding matrix from the second base station, then calculating, by the joint transmission user, a decoding matrix based on the first data demodulation reference signal and the second data demodulation reference signal, wherein the joint transmission user can decode data from the first base station and the second base station based on the decoding matrix;
wherein the number of columns of the first feedback equivalent channel matrix and the number of columns of the second equivalent channel matrix are both equal to or less than the sum of the number of data layers of the first base station and the number of data layers of the second base station.

2. The method according to claim 1, characterized in that, in the S3, the first feedback equivalent channel matrix has the same column space as a conjugate transpose matrix of the first equivalent channel matrix, and the second feedback equivalent channel matrix has the same column space as a conjugate transpose matrix of the second equivalent channel matrix.

3. The method according to claim 2, characterized in that, the joint transmission user sets the number of columns of the first feedback equivalent channel matrix to a rank of the first equivalent channel matrix and sets the number of columns of the second feedback equivalent channel matrix to a rank of the second equivalent channel matrix wherein the rank of the first equivalent channel matrix is \hat{v}, and the joint transmission user performs singular value decomposition on the conjugate transpose matrix of the first equivalent channel matrix, and sets the first feedback equivalent channel matrix as a channel matrix composed of the first \hat{v} left singular vectors of the left singular vector matrix obtained after the singular value decomposition; and
the rank of the second equivalent channel matrix is \hat{v}′, and the joint transmission user performs singular value decomposition on the conjugate transpose matrix of the second equivalent channel matrix, and sets the second feedback equivalent channel matrix as a channel matrix composed of the first \hat{v}′ left singular vectors of the left singular vector matrix obtained after the singular value decomposition.

4. (canceled)

5. The method according to claim 1, characterized in that, in the S3, the joint transmission user feeds back a first feedback equivalent channel matrix to the first base station, so that the first base station calculates the first pre-coding matrix based on the first feedback equivalent channel matrix; and the joint transmission user feeds back a second feedback equivalent channel matrix to the second base station, so that the second base station calculates the second pre-coding matrix based on the second feedback equivalent channel matrix,
wherein the first pre-coding matrix and the second pre-coding matrix are used for avoiding interference on a signal of the joint transmission user from other users served by the first base station and the second base station, and
the first pre-coding matrix is orthogonal to channels of users other than the joint transmission user served by the first base station and the second pre-coding matrix is orthogonal to the channels of users other than the joint transmission user served by the second base station.

6. (canceled)

7. The method according to claim 1, characterized in that, in the S2, the joint transmission user calculates a first channel matrix of the first channel based on the first channel state information reference signal and a second channel matrix of the second channel based on the second channel state information reference signal, and then the joint transmission user calculates a merging matrix based on the first channel matrix and the second channel matrix, the first equivalent channel matrix is a matrix obtained after the first channel matrix and the merging matrix are merged, and the second equivalent channel matrix is a matrix obtained after the second channel matrix and the merging matrix are merged.

8. The method according to claim 7, characterized in that, the number of data layers transmitted by the first channel is v, the number of data layers transmitted by the second channel is v′, the number of receiving antennas of the joint transmission user is Nᵣ, and the merging matrix is W₁, satisfying W₁∈C^{(v+v′)×N}^{ᵣ}, and
the joint transmission user concatenates the first channel matrix and the second channel matrix, and performs singular value decomposition on the concatenated matrix to obtain the merging matrix, wherein
the merging matrix is a conjugate transpose matrix of a sub-matrix composed of the first v+v′ columns of a left singular vector matrix obtained after the decomposition;
or, the merging matrix is a selection matrix with v+v′ rows and a number of columns equal to the number of the receiving antennas of the joint transmission user.

9. (canceled)

10. The method according to claim 7, characterized in that, in the S5, the merging matrix is W₁, the first channel matrix is H_{1,1}, the first pre-coding matrix is F₁, the second channel matrix is H_{2,1}, the second pre-coding matrix is F′₁, and the joint transmission user sets the decoding matrix W₂ to an inverse of W₁[H_{1,1}F₁,H_{2,1}F′₁].

11. The method according to claim 1, characterized in that, further comprising S4 between the S3 and the S5:
detecting, by the joint transmission user, whether a concatenated matrix of the pre-coded first equivalent channel matrix and the second equivalent channel matrix is under-rank according to the first data demodulation reference signal and the second data demodulation reference signal;
if it is not under-rank, proceed to the S5;
if it is under-rank, the joint transmission user feeds back to the corresponding first base station and/or second base station an indication information indicating a target pre-coding vector needing to be adjusted of the first pre-coding matrix and/or the second pre-coding matrix, so that the first base station and/or the second base station adjust the target pre-coding vector after receiving the indication information and obtain a modified first pre-coding matrix and/or a modified second pre-coding matrix, and enable the first base station and/or the second base station to transmit the first data demodulation reference signal and/or the second data demodulation reference signal pre-coded with the modified first pre-coding matrix and/or the modified second pre-coding matrix back to the joint transmission user,
wherein, in the S4, the joint transmission user checks column by column that whether or not each column of the pre-coded first equivalent channel matrix and the pre-coded second equivalent channel matrix can be linearly represented by the remaining columns approximatively, and if at least one column can be linearly represented by the remaining columns approximatively, it is determined that it is under-rank, and the pre-coding vector of the corresponding column in the first pre-coding matrix and/or the second pre-coding matrix is determined as the target pre-coding vector needing to be adjusted.

12. (canceled)

13. A wireless communication device, characterized in that, the wireless communication device can perform channel feedback with a base station using the method according to claim 1 under non-coherent joint transmission.

14. A method for processing channel feedback at a base station side under non-coherent joint transmission, characterized in that, the method comprises the following steps:
S1: transmitting, by a first base station, a first channel state information reference signal to a joint transmission user, so that the joint transmission user calculates a first equivalent channel matrix of a first channel from the first base station to the joint transmission user based on the first channel state information reference signal; and transmitting, by a second base station, a second channel state information reference signal to the joint transmission user, so that the joint transmission user calculates a second equivalent channel matrix of a second channel from the second base station to the joint transmission user based on the second channel state information reference signal;
S2: receiving, by the first base station, a first feedback equivalent channel matrix based on the first equivalent channel matrix feedback from the joint transmission user, and receiving, by the second base station, a second feedback equivalent channel matrix based on the second equivalent channel matrix feedback from the joint transmission user;
S3: calculating, by the first base station, a first pre-coding matrix based on the first feedback equivalent channel matrix, and transmitting a first data demodulation reference signal pre-coded by the first pre-coding matrix to the joint transmission user; calculating, by the second base station, a second pre-coding matrix based on the second feedback equivalent channel matrix, and transmitting a second data demodulation reference signal pre-coded by the second pre-coding matrix to the joint transmission user, wherein the first pre-coding matrix and the second pre-coding matrix are used for avoiding interference on a signal of the joint transmission user from other users served by the first base station and the second base station;
wherein the number of columns of the first feedback equivalent channel matrix and the number of columns of the second equivalent channel matrix are both equal to or less than the sum of the number of data layers of the first base station and the number of data layers of the second base station.

15. The method according to claim 14, characterized in that, in the S2, the first feedback equivalent channel matrix has the same column space as a conjugate transpose matrix of the first equivalent channel matrix, and the second feedback equivalent channel matrix has the same column space as a conjugate transpose matrix of the second equivalent channel matrix, and
in the S3, the first base station makes the first pre-coding matrix be orthogonal to channels of users other than the joint transmission user served by the first base station and the second base station makes the second pre-coding matrix be orthogonal to the channels of users other than the joint transmission user served by the second base station,
wherein the first base station and the second base station do not share the transmitted data and channel state information of the first channel and the second channel to the joint transmission user.

16. The method according to claim 15, characterized in that, the number of columns of the first feedback equivalent channel matrix is set to a rank of the first equivalent channel matrix and the number of columns of the second feedback equivalent channel matrix is set to a rank of the second equivalent channel matrix,
wherein the rank of the first equivalent channel matrix is \hat{v}, and the first feedback equivalent channel matrix received by the first base station is a channel matrix as follows: the channel matrix is composed of the first \hat{v} left singular vectors of a left singular vector matrix obtained after singular value decomposition of the conjugate transpose matrix of the first equivalent channel matrix; and
the rank of the second equivalent channel matrix is \hat{v}′, and the second feedback equivalent channel matrix received by the second base station is a channel matrix as follows: the channel matrix is composed of the first \hat{v}′ left singular vectors of a left singular vector matrix obtained after singular value decomposition of the conjugate transpose matrix of the second equivalent channel matrix.

17.-18. (canceled)

19. The method according to claim 14, characterized in that, after the S3, if a concatenated matrix of the first equivalent channel matrix pre-coded by the first pre-coding matrix and the second equivalent channel matrix pre-coded by a second pre-coding matrix is under-rank, the method further comprises the following step S4:
receiving, by the first base station and/or the second base station, indication information from the joint transmission user, indicating a target pre-coding vector needing to be adjusted of the first pre-coding matrix and/or the second pre-coding matrix, subsequently adjusting, by the first base station and/or the second base station, the target pre-coding vector and obtaining a modified first pre-coding matrix and/or a modified second pre-coding matrix, and
transmitting the first data demodulation reference signal and/or the second data demodulation reference signal pre-coded by the modified first pre-coding matrix and/or the modified second pre-coding matrix to the joint transmission user.

20. The method according to claim 19, characterized in that, the modified first pre-coding matrix and/or the modified second pre-coding matrix are obtained by:
respectively replacing, by the first base station and/or the second base station, the target pre-coding vector needing to be adjusted in the first pre-coding matrix and/or the second pre-coding matrix with a right singular vector which is not currently used in a first block diagonal pre-coding matrix and/or a second block diagonal pre-coding matrix after the indication information is received;
wherein the first block diagonal pre-coding matrix/the second block diagonal pre-coding matrix is obtained by multiplying the first equivalent channel matrix/the second equivalent channel matrix with a first orthogonal matrix/a second orthogonal matrix, wherein the column space of the first orthogonal matrix is orthogonal to the channels of users other than the joint transmission user served by the first base station, and the column space of the second orthogonal matrix is orthogonal to the channels of users other than the joint transmission user served by the second base station, and a linear combination of columns in the first orthogonal matrix/the second orthogonal matrix can represent each column in the first pre-coding matrix/the second pre-coding matrix.

21. The method according to claim 20, characterized in that, after the indication information is received, the first base station and/or the second base station respectively replaces the target pre-coding vector needing to be adjusted in the first pre-coding matrix and/or the second pre-coding matrix with the (v+1)^{th} and/or the (v′+1)^{th} right singular vector in the first block diagonal pre-coding matrix and/or the second block diagonal pre-coding matrix, wherein v is the number of data layers transmitted by the first channel, and v′ is the number of data layers transmitted by the second channel.

22. (canceled)

23. A base station, wherein the base station can use the method according to claim 14 to process channel feedback from a wireless communication device under non-coherent joint transmission.

24. A method for adjusting a pre-coding matrix at a base station side under non-coherent joint transmission, wherein under the non-coherent joint transmission, a first base station transmitting data pre-coded by a first pre-coding matrix to a joint transmission user via a first channel, a second base station transmitting data pre-coded by a second pre-coding matrix to the joint transmission user via a second channel, the first channel having a first equivalent channel matrix, and the second channel having a second equivalent channel matrix, and the first base station and the second base station do not share the transmitted data and channel state information of the first channel and the second channel to the joint transmission user,
characterized in that, the method comprises the following steps:
S1: receiving, by the first base station and/or the second base station, indication information from the joint transmission user, and determining that the pre-coded first equivalent channel matrix and/or the second equivalent channel matrix are under-rank based on the indication information;
S2: adjusting, by the first base station and/or the second base station, the target pre-coding vector and obtaining a modified first pre-coding matrix and/or a modified second pre-coding matrix according to the target pre-coding vector needing to be adjusted of the first pre-coding matrix and/or the second pre-coding matrix indicated in the indication information, and transmitting the first data demodulation reference signal and/or the second data demodulation reference signal pre-coded by the modified first pre-coding matrix and/or the modified second pre-coding matrix to the joint transmission user.

25. The method according to claim 24, characterized in that, the modified first pre-coding matrix and/or the modified second pre-coding matrix are obtained by:
respectively replacing, by the first base station and/or the second base station, the target pre-coding vector needing to be adjusted in the first pre-coding matrix and/or the second pre-coding matrix with a right singular vector which is not currently used in a first block diagonal pre-coding matrix and/or a second block diagonal pre-coding matrix after the indication information is received;
wherein the first block diagonal pre-coding matrix/the second block diagonal pre-coding matrix is obtained by multiplying the first equivalent channel matrix/the second equivalent channel matrix with a first orthogonal matrix/a second orthogonal matrix, wherein the column space of the first orthogonal matrix is orthogonal to the channels of users other than the joint transmission user served by the first base station, and the column space of the second orthogonal matrix is orthogonal to the channels of users other than the joint transmission user served by the second base station, and a linear combination of columns in the first orthogonal matrix/the second orthogonal matrix can represent each column in the first pre-coding matrix/the second pre-coding matrix.

26. The method according to claim 25, characterized in that, after the indication information is received, the first base station and/or the second base station respectively replaces the target pre-coding vector needing to be adjusted in the first pre-coding matrix and/or the second pre-coding matrix with the (v+1)^{th} and/or the (v′+1)^{th} right singular vector in the first block diagonal pre-coding matrix and/or the second block diagonal pre-coding matrix, wherein v is the number of data layers transmitted by the first channel, and v′ is the number of data layers transmitted by the second channel.

27. (canceled)

28. A base station, characterized in that, the base station can use the method according to claim 24 to adjust the pre-coding matrix for channel matrix from the base station to a joint transmission user under non-coherent joint transmission.
